(19) United States
(12) Patent Application Publication
(10) Pub. No.: US 2026/0366102 A1
(43) Pub. Date: Nov. 19, 2026

(54) METHOD FOR MANUFACTURING ANTIMONY-TIN SOLID SOLUTION ALLOY, ELECTRODE MATERIAL MANUFACTURED THEREBY AND SECONDARY BATTERY INCLUDING THE SAME

(71) Applicant: KOREA INSTITUTE OF ENERGY RESEARCH, Daejeon (KR)

(72) Inventors: Sun Hwa YEON, Sejong-si (KR); Kyoung Hee SHIN, Daejeon (KR); Chang Soo JIN, Sejong-si (KR); Dong Ha KIM, Daejeon (KR); Se Kook PARK, Daejeon (KR); Seung Hae HWANG, Daejeon (KR); Donghee GUEON, Daejeon (KR); Jae Yeol PARK, Daejeon (KR)

(73) Assignee: KOREA INSTITUTE OF ENERGY RESEARCH, Daejeon (KR)

(21) Appl. No.: 19/535,458

(22) Filed: Feb. 10, 2026

(30) Foreign Application Priority Data
Feb. 11, 2025 (KR) 10-2025-0017554

(51) Int. Cl. C22C 12/00; B22F 9/04; C22C 1/04; H01M 4/38; H01M 10/0525; H01M 10/054

(52) U.S. Cl. CPC C22C 12/00; B22F 9/04; C22C 1/04; H01M 4/38; H01M 10/0525; H01M 10/054; B22F 2009/041; B22F 2009/043; B22F 2301/30; B22F 2998/10; B22F 2999/00

(57) ABSTRACT

The present disclosure relates to a method for producing an antimony-tin solid solution alloy, including a step (a) of producing an antimony-tin solid solution alloy by applying mechanical energy to a powder mixture of antimony powder and tin powder. According to the disclosure, an antimony-tin solid solution alloy may be simply and efficiently produced using ball milling without using complex and inefficient processes such as chemical methods. Also, when the antimony-tin solid solution alloy produced by the method is used as an anode active material for a lithium, sodium or potassium secondary battery, it is possible to significantly suppress the problem of rapid performance deterioration due to volume change, which occurs in conventional alloy-based electrode materials for secondary batteries, thereby ensuring high life characteristics, and it is possible to realize a high-performance lithium, sodium or potassium secondary battery system exhibiting high-capacity and high-output characteristics.

### CROSS-REFERENCE TO RELATED APPLICATION(S)

This application claims priority from and the benefit of Korean Patent Application No. 10-2025-0017554, filed on Feb. 11, 2025, which is hereby incorporated by reference for all purposes as if set forth herein.

### BACKGROUND

### TECHNICAL FIELD

The present disclosure relates to a method for producing an antimony-tin solid solution alloy, an electrode material for a secondary battery produced thereby, and a secondary battery including the same.

### RELATED ART

Antimony (Sb) is attracting attention as a promising anode material for lithium secondary batteries as well as next-generation secondary batteries such as sodium and potassium secondary batteries due to its high theoretical capacity (660 mAh/g, 1,890 mAh/cm³) and excellent chemical and thermal stability.

However, antimony (Sb) undergoes high volume expansion during charge and discharge processes in lithium, sodium, and potassium secondary batteries. This volume expansion causes cracks inside and on the surface of the electrode, which deteriorates the life characteristics of the battery. The problem of volume expansion of antimony during the charge and discharge processes can be suppressed by forming a complex with a solid material or producing a compound, but the problem of capacity loss and deterioration of life characteristics due to volume expansion still remains unresolved.

Meanwhile, an antimony (Sb)-tin (Sn) solid solution alloy maintains the reaction mechanism of antimony that reacts stably with lithium, sodium, or potassium, unlike conventional antimony-based compounds. Furthermore, the dissolution of a small amount of tin in antimony provides the advantage of improving electrical conductivity and mechanical properties, thereby effectively alleviating the volume expansion problem of antimony.

However, since previously reported compound production processes require expensive and complex hydrothermal synthesis or chemical synthesis, the development of a simpler and more efficient synthesis technique is required.

### Prior Art Documents

### Patent Documents

Patent Document 1 Korean Patent Application Publication No. 10-2015-0146437 (published on December 31, 2015)

Patent Document 2 Korean Patent Application Publication No. 10-2017-0057144 (published on May 24, 2017)

Patent Document 3 Korean Patent Application Publication No. 10-2023-0010219 (published on January 18, 2023)

### SUMMARY

An object of the present disclosure is to provide a method of producing an antimony-tin solid solution alloy containing tin using a simple and efficient method without using complex and inefficient processes such as conventional hydrothermal synthesis and chemical synthesis, an electrode active material for a lithium, sodium or potassium secondary battery including the same, and a lithium, sodium or potassium secondary battery using the same.

To achieve the above object, the present disclosure provides a method for producing an antimony-tin solid solution alloy, comprising a step (a) of producing an antimony-tin solid solution alloy by applying mechanical energy to a powder mixture of antimony powder and tin powder using ball milling as a simple mechanical synthesis method.

The step (a) is a step of producing an antimony-tin solid solution alloy by applying mechanical energy to a powder mixture of antimony powder and tin powder.

The step (a) is a process that applies high mechanical energy at a rotation speed of 500 to 5,000 rpm, and may be performed by any known ball milling device, which is used for a ball milling process and is capable of applying high mechanical energy, such as a high-energy Spex mill, a vibrotary mill, a Z-mill, a planetary ball-mill, a vortex mill, or an attrition mill.

In the step (a), an antimony-tin solid solution alloy was simply produced by dissolving tin atoms in the crystal structure of antimony using a small amount (1 wt% to 10 wt%) of tin powder by high-energy ball milling. XRD analysis of the produced alloy showed that no other heterogeneous phases other than tin existed, indicating that tin atoms were dissolved in the crystal structure of antimony.

In another aspect of the present disclosure, the present disclosure provides an anode material for a lithium, sodium or potassium secondary battery comprising the antimony-tin solid solution alloy produced by the above-described production method.

In still another aspect of the present disclosure, the present disclosure provides a lithium, sodium or potassium secondary battery comprising the anode material.

The method for producing an antimony (Sb)-tin (Sn) solid solution alloy according to the present disclosure may efficiently produce an antimony-tin solid solution alloy using ball milling, a simple solid synthesis method, without using conventional complex and inefficient hydrothermal synthesis and chemical synthesis methods.

In addition, when the antimony-tin solid solution alloy produced according to the present disclosure is used as an electrode active material for a lithium, sodium or potassium secondary battery, it is possible to realize a secondary battery system having excellent cycle life while maintaining high capacity and reversibility.

### BRIEF DESCRIPTION OF THE DRAWINGS

FIG. 1 is a process flow diagram sequentially showing each step of a method for producing an antimony-tin solid solution alloy according to the present disclosure.

FIG. 2 is a schematic view showing a secondary battery including an antimony-tin solid solution alloy according to the present disclosure as an electrode active material for a lithium, sodium or potassium secondary battery.

FIG. 3 is a schematic view showing a secondary battery including an antimony-tin solid solution alloy according to the present disclosure as an electrode active material for a lithium, sodium or potassium secondary battery.

FIG. 4 is a graph showing the results of X-ray diffraction analysis of the antimony-tin solid solution alloy according to the present disclosure.

FIG. 5A is a graph showing the cycle characteristics of a lithium secondary battery including, as an electrode active material, an antimony-tin solid solution alloy according to an example of the present disclosure.

FIG. 5B is a graph showing the cycle characteristics of a sodium secondary battery including, as an electrode active material, an antimony-tin solid solution alloy according to an example of the present disclosure.

FIG. 5C is a graph showing the cycle characteristics of a potassium secondary battery including, as an electrode active material, an antimony-tin solid solution alloy according to an example of the present disclosure.

### DETAILED DESCRIPTION

In the following description of the present disclosure, the detailed description of related known function or configuration will be omitted when it may unnecessarily obscure the subject matter of the present disclosure.

Embodiments according to the concept of the present disclosure may be subjected to various modifications and may have various forms, and thus specific embodiments will be shown in the drawings and described in detail in the present specification or application. However, this is not intended to limit the present disclosure to specific embodiments, and it should be understood that the present disclosure includes all modifications, equivalents or replacements included in the spirit and technical scope of the present disclosure.

Terms used herein are only to describe specific embodiments and are not intended to limit the scope of the present disclosure. Singular expressions include plural expressions unless otherwise specified in the context thereof.

In the present specification, terms such as “include”, "comprise", "have", etc., are intended to denote the existence of stated characteristics, numbers, steps, operations, components, parts, or combinations thereof, but do not exclude the probability of existence or addition of one or more other characteristics, numbers, steps, operations, components, parts, or combinations thereof.

Hereinafter, the present disclosure will be described in detail.

The present disclosure provides a method for producing an antimony-tin solid solution alloy, including a step (a) of producing an antimony-tin solid solution alloy by applying mechanical energy to a powder mixture of antimony powder and tin powder using ball milling.

The step (a) is a step of producing an antimony-tin solid solution alloy by applying mechanical energy to a powder mixture of antimony powder and tin powder.

The step (a) is a process that applies high mechanical energy at a rotation speed of 500 to 5,000 rpm, and may be performed by any known ball milling device, which is used for a ball milling process and is capable of applying high mechanical energy, such as a high-energy Spex mill, a vibrotary mill, a Z-mill, a planetary ball-mill, a vortex mill, or an attrition mill.

In the step (a), an antimony-tin solid solution alloy was simply produced by dissolving tin atoms in the crystal structure of antimony using a small amount (1 wt% to 10 wt%) of tin powder by high-energy ball milling. XRD analysis of the produced alloy showed that no other heterogeneous phases other than tin existed, indicating that tin atoms were dissolved in the crystal structure of antimony.

In another aspect of the present disclosure, the present disclosure provides an anode material for a lithium, sodium or potassium secondary battery including the antimony-tin solid solution alloy produced by the above-described production method.

In still another aspect of the present disclosure, the present disclosure provides a lithium, sodium or potassium secondary battery including the anode material.

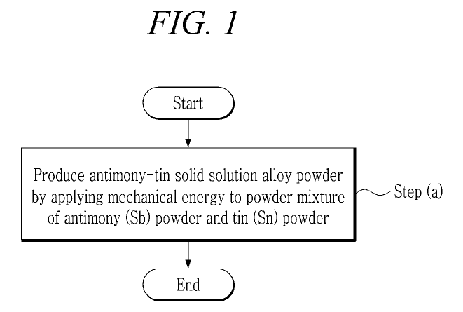

FIG. 1 is a block diagram schematically showing a process of synthesizing an antimony-tin solid solution alloy.

The antimony-tin solid solution alloy produced by the above-described production method has excellent cycle life while maintaining high capacity and reversibility, and is therefore highly suitable for use as an electrode active material for a lithium, sodium or potassium secondary battery.

The present disclosure provides a lithium, sodium or potassium secondary battery including the antimony-tin solid solution alloy.

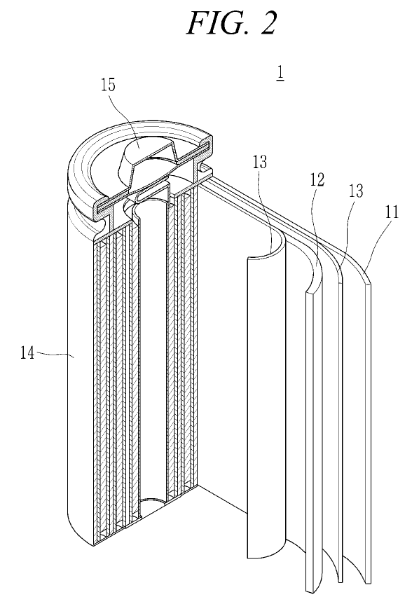

FIG. 2 is a schematic view showing a secondary battery including an antimony-tin solid solution alloy according to the present disclosure as an electrode active material for a lithium, sodium or potassium secondary battery.

Referring to FIG. 2, a secondary battery 1 may include a cathode 12, an anode 11, and a separator 13 disposed between the cathode 12 and the anode 11. The secondary battery 1 may further include an electrolyte (not shown), a battery case 14, and a sealing member 15 sealing the battery case 14. This secondary battery 1 may be manufactured by sequentially stacking the cathode 12, the anode 11, and the separator 13, and then housing them in the battery case 14 in a wound state.

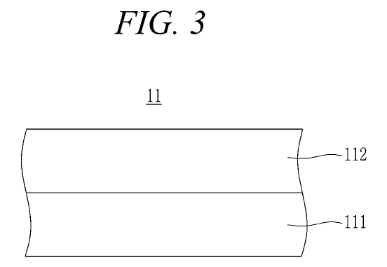

FIG. 3 is a schematic view showing a secondary battery including an antimony-tin solid solution alloy according to the present disclosure as an electrode active material for a lithium, sodium or potassium secondary battery.

Referring to FIG. 3, the anode 11 may include a current collector 111 and an active material layer 112 formed on the current collector 111. The active material layer 112 includes the antimony-tin solid solution alloy according to the present disclosure. The anode 11 may further include a water-insoluble binder such as polyvinylidene fluoride (PVdF), or a water-soluble binder such as polyethyleneimine, polyaniline, polythiophene, polyacrylic acid (PAA), carboxymethylcellulose (CMC), or styrene-butadiene rubber (SBR).

Hereinafter, examples of the present disclosure will be described. However, the present disclosure is not limited to the examples described herein and may be embodied in a variety of different forms. Rather, the examples described herein are provided so that this disclosure will be thorough and complete, and will fully convey the spirit of the present disclosure to those skilled in the art.

Example Production of antimony-tin solid solution alloy and lithium, sodium and potassium secondary batteries including the same

(1) Production of antimony-tin solid solution alloy

After mixing 90 wt% to 99 wt% of antimony (Sb) powder and a small amount (1 wt% to 10 wt%) of tin (Sn) powder, the powder mixture together with 3/8-inch balls was placed in a cylindrical vial made of SKD11 with a diameter of 5.5 cm and a height of 9 cm together. The vial was placed in a vibrating mill (Spex 8000), and then mechanical synthesis was performed at a rotation speed of 900 rpm.

At this time, the weight ratio of the balls to the powder mixture was maintained at 20:1, and mechanical synthesis was performed in a glove box under an argon gas atmosphere in order to minimize the influence of oxygen and moisture. The mechanical synthesis was performed for 6 to 12 hours, thereby producing an antimony-tin solid solution alloy.

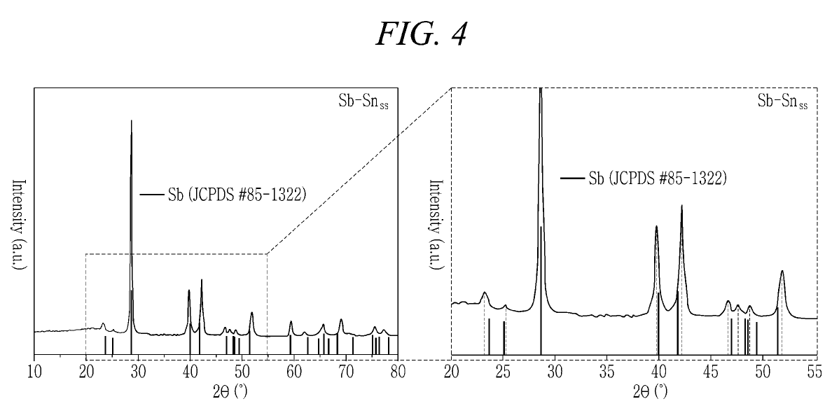

FIG. 4 is a graph showing the results of X-ray diffraction analysis of the antimony-tin solid solution alloy. The results of the analysis showed that no other heterogeneous phases other than tin existed, indicating that tin atoms were dissolved in the crystal structure of antimony.

(2) Evaluation of electrochemical performance of antimony-tin solid solution alloy and lithium, sodium and potassium secondary batteries including the same

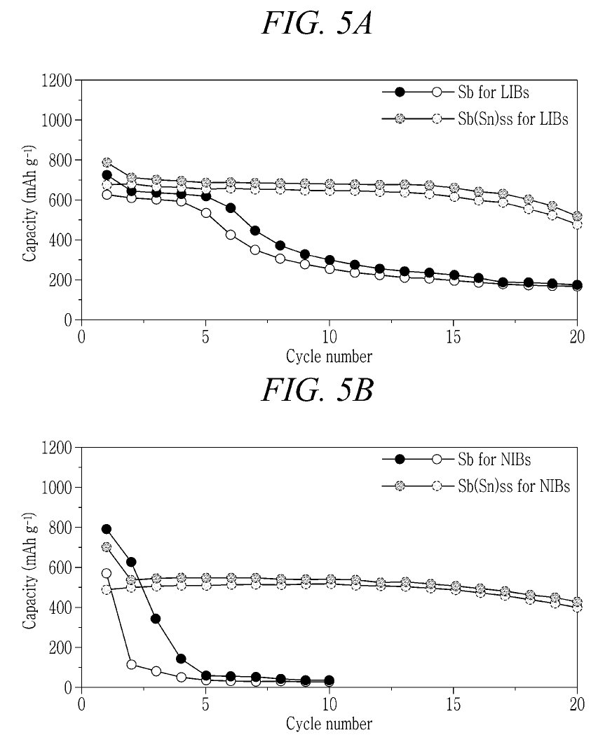

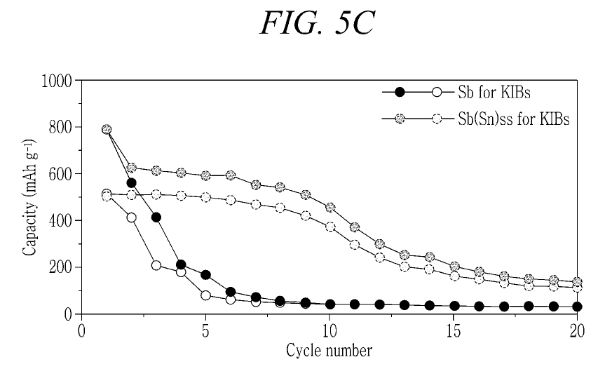

FIGS. 5A, 5B and 5C are graphs showing experimental results for the electrochemical cycle life characteristics of lithium, sodium and potassium secondary battery half-cells including the antimony-tin solid solution alloy.

FIG. 5A is a graph showing experimental results for the cycle life characteristics of a lithium secondary battery half-cell including the antimony-tin solid solution alloy. As shown therein, when the antimony-tin solid solution alloy of the present disclosure was applied as an electrode material for a lithium secondary battery half-cell, it exhibited excellent cycle life characteristics without any change in capacity even for several cycles.

FIG. 5B is a graph showing experimental results for the cycle life characteristics of a sodium secondary battery half-cell including the antimony-tin solid solution alloy. As shown therein, when the antimony-tin solid solution alloy of the present disclosure was applied as an electrode material for a sodium secondary battery half-cell, it exhibited excellent cycle life characteristics without any change in capacity even for several cycles.

FIG. 5C is a graph showing experimental results for the cycle life characteristics of a potassium secondary battery half-cell including the antimony-tin solid solution alloy. As shown therein, when the antimony-tin solid solution alloy of the present disclosure was applied as an electrode material for a potassium secondary battery half-cell, it exhibited excellent cycle life characteristics without any change in capacity even for several cycles.

As described above, according to the present disclosure, when the antimony-tin solid solution alloy is used as an anode material for a lithium, sodium or potassium secondary battery, it is possible to minimize the problem of deterioration in life characteristics due to volume change of the anode material, which occurs in the anode during charging and discharging of the secondary battery.

Accordingly, mechanical stability, which is considered to be most important in secondary battery anodes, may be ensured, and capacity and cycle life characteristics may also be improved.

While the embodiments of the present disclosure have been described with reference to the accompanying drawings, those skilled in the art to which the present disclosure pertains will appreciate that the present disclosure may be embodied in other specific forms without departing from the technical spirit or essential characteristics of the present disclosure. Therefore, the embodiments described above should be understood to be exemplary in all aspects and not restrictive.

What is claimed is:

1. A method for producing an antimony-tin solid solution alloy, comprising a step (a) of producing an antimony-tin solid solution alloy by applying mechanical energy to a powder mixture of antimony powder and tin powder.

2. The method of claim 1, wherein the step (a) is performed by producing the antimony-tin solid solution alloy in which 1 wt% to 10 wt% of tin is dissolved in antimony, so that there is no change in a crystal structure of antimony, but there is a change in interplanar spacing.

3. The method of claim 1, wherein the step (a) is performed by producing the antimony-tin solid solution alloy by subjecting the powder mixture of antimony powder and tin powder to high-energy milling at a rotation speed of 500 to 5,000 rpm.

4. An electrode active material for a secondary battery comprising an antimony-tin solid solution alloy produced by the method set forth in any one of claims claim 1 to 3.

5. A secondary battery comprising the electrode active material set forth in claim 4.

6. The secondary battery of claim 5, which is a lithium secondary battery, a sodium secondary battery, or a potassium secondary battery.
